(19) United States
(12) Patent Application Publication
(10) Pub. No.: US 2006/0199165 A1
(43) Pub. Date: Sep. 7, 2006

(54) Apparatuses, methods and systems to deploy testing facilities on demand

(76) Inventors: Christopher Crowhurst, Whitehall, MD (US); Thomas George Cassidy JR., Frederick, MD (US); Richard Alan Guenther, Kensington, MD (US)

Correspondence Address: MORGAN & FINNEGAN, L.L.P., 3 World Financial Center, New York, NY, 10281-2101, US

(21) Appl. No.: 11/073,102

(22) Filed: Mar. 3, 2005

(51) Int. Cl. G09B 3/00

(52) U.S. Cl. 434/350

(57) ABSTRACT

The disclosure details the implementation of apparatuses, methods and systems for an on Demand Test Facility Provider System (DTFPS). The DTFPS enables the deployment of testing facilities on demand. Generally, the invention enables interactions between four actors: a testing authority, a testing provider, a testing facility, and a test candidate. The testing authority is a body having the credentials and authority to conduct testing over a pool of candidates. The test provider is a service provider arranging for the administration of testing. The test provider offloads the logistics of test administration from the testing authority and coordinates with test facilities, candidates, and the testing authority to provide the administration of various tests. Various components of the DTFPS take on the role of a test provider enabling the administration of a wide spectrum of tests for different groups of people. As such, the DTFPS may offer various types of tests to candidates by acting as a proxy for a testing authority. The candidates in many instances must qualify to sit for the tests. The test provider, e.g., the DTFPS, enables candidates to schedule tests, provides facilities for the actual test, collects and may grade the results, and may report the results to the testing authorities and candidates.

### FIELD

The present invention relates generally to an apparatus, method and system to provide testing. More particularly, the disclosed invention relates to an apparatus, method and system to facilitate the provision of testing facilities on behalf of testing authorities based on the demands for testing created by testing candidates.

### BACKGROUND

Testing Facilities

Typically, testing facilities are provided by a testing authority responsible for the testing. As such, schools provide their own facilities with which to test their own students for their enrolled courses. Similarly, testing or accreditation agencies will provide or arrange for their own testing facilities to administer tests like State Bar examinations in various states. Typically, the testing authority would create tests manually for each test administration, administer the logistics of the testing facilities, administer the logistics of the test candidates, and administer and grade the completed tests.

### SUMMARY

Testing authorities excel at setting the standards of competency for candidate test takers as required for a given field of study, but they do not necessarily excel at logistics of mobilizing test facilities and events. Moreover, as each test authority is typically responsible for its own singular tests, they do not or cannot achieve economies of scale that would be achieved by the present invention. Ultimately, a Demand Test Facility Provider System (“the DTFPS”), as described in greater detail below, enables candidates to take tests at test facilities on behalf of a testing authority.

In one embodiment of the present invention, a method is taught for determining the availability of testing facilities. The method comprises: obtaining desired characteristics for a testing facility and then sending a request for testing facility availability. The request is triggered by updates to capacity demand for the testing facility. The method goes on to specify receiving a response to the request from a testing facility and then updating the testing facility database with the response.

In another embodiment of the present invention, the method seeks to increase test facility availability. The method comprises: receiving a request for a test event, wherein the request includes testing facility requirements, and subsequently searching for testing facilities in a testing facilities database that match the testing facility requirements. The method generates approvals for test facilities identified from searching the testing facilities database and establishes new testing facilities, if no testing facilities are identified from searching. The method then updates the testing facilities database.

### BRIEF DESCRIPTION OF THE DRAWINGS

The accompanying drawings illustrate various non-limiting, exemplary, inventive aspects in accordance with the present disclosure:

FIG. 1 is of a mixed data and logic flow diagram illustrating embodiments of capacity planning for an on Demand Test Facility Provider System (DTFPS);

FIG. 2 is of a mixed data and logic flow diagram illustrating embodiments of candidate test scheduling and facility demand creation;

FIG. 3 is of a mixed data and logic flow diagram illustrating embodiments of test generation and provision;

FIG. 4 is of a mixed data and logic flow diagram illustrating embodiments of test grading and reporting.

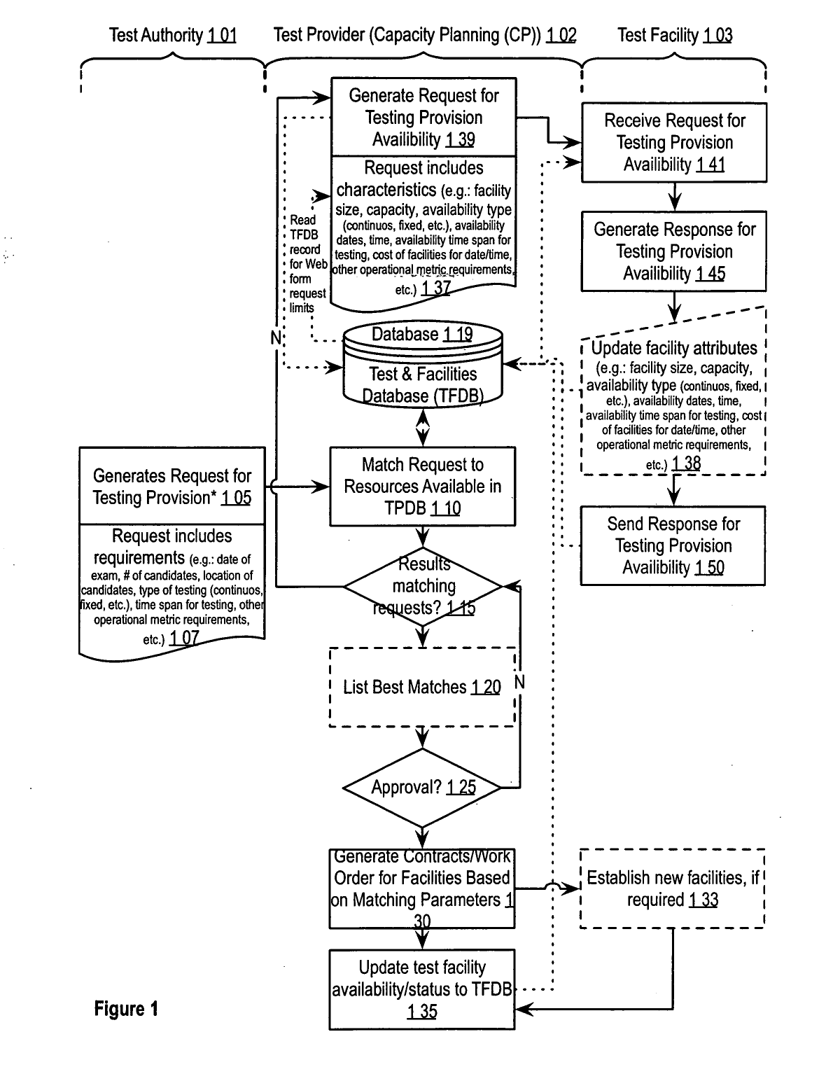

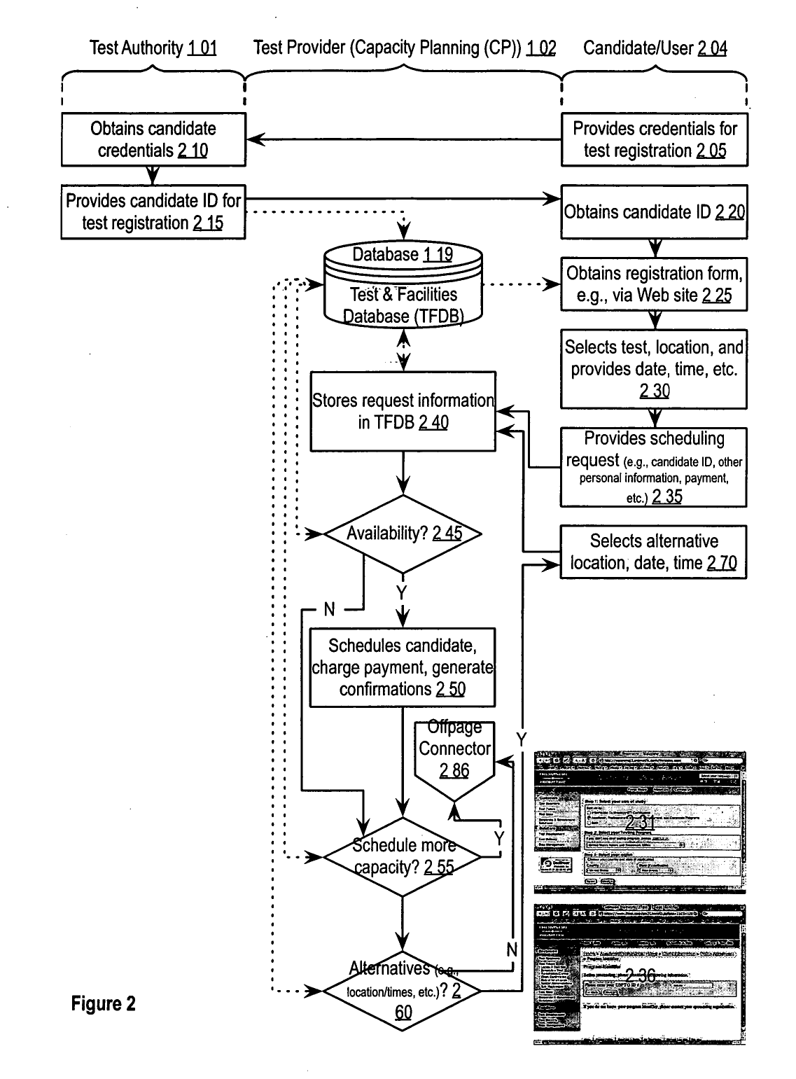

The leading number of each reference number within the drawings indicates the first figure in which that reference number is introduced. As such, reference number 101 is first introduced in FIG. 1. Reference number 201 is first introduced in FIG. 2, etc.

### DETAILED DESCRIPTION

Demand Test Facility Provider System

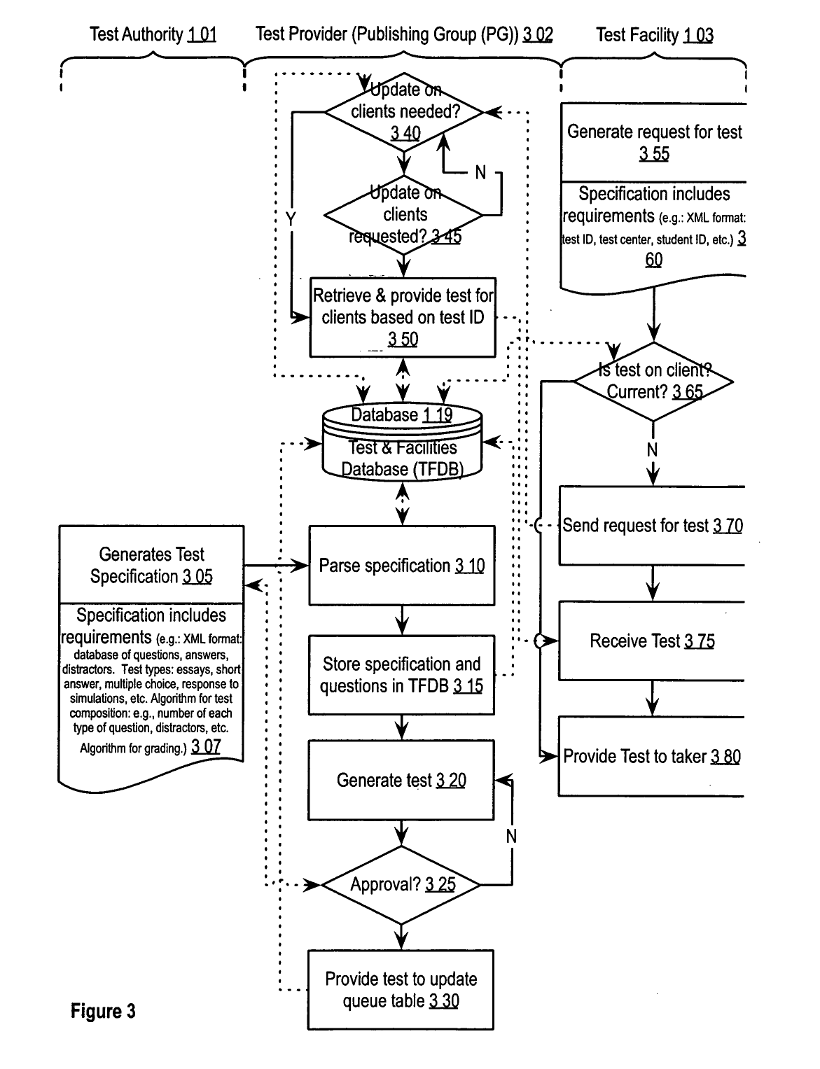

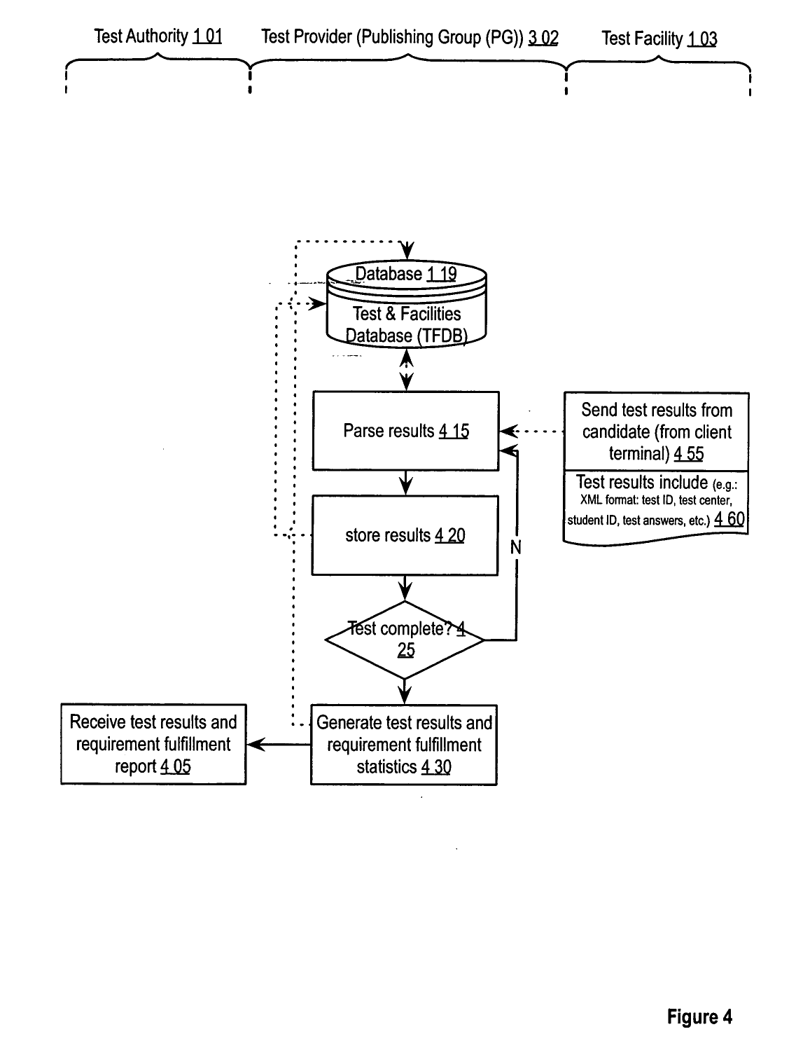

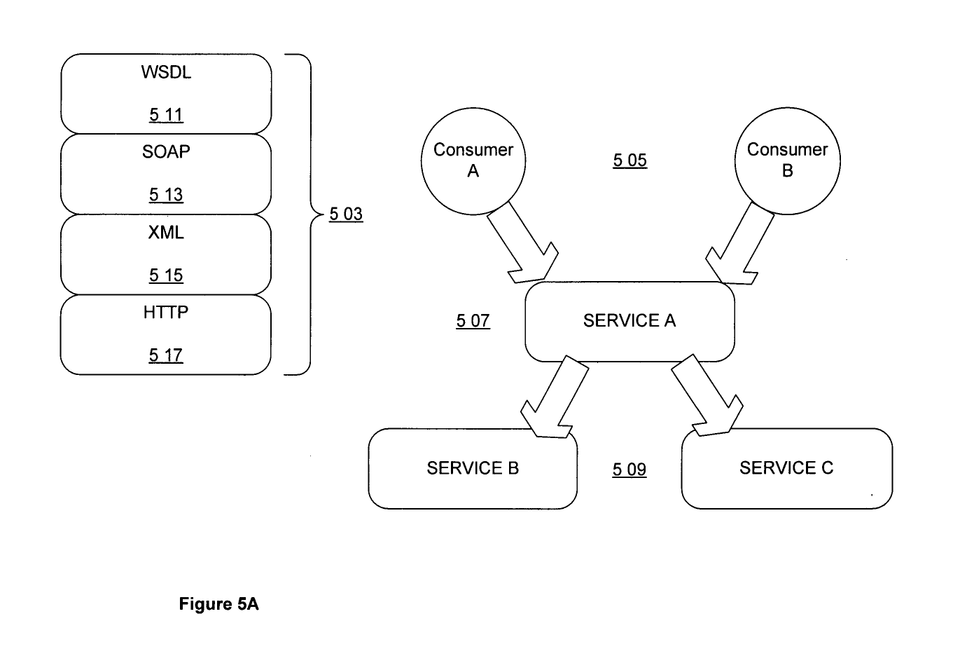

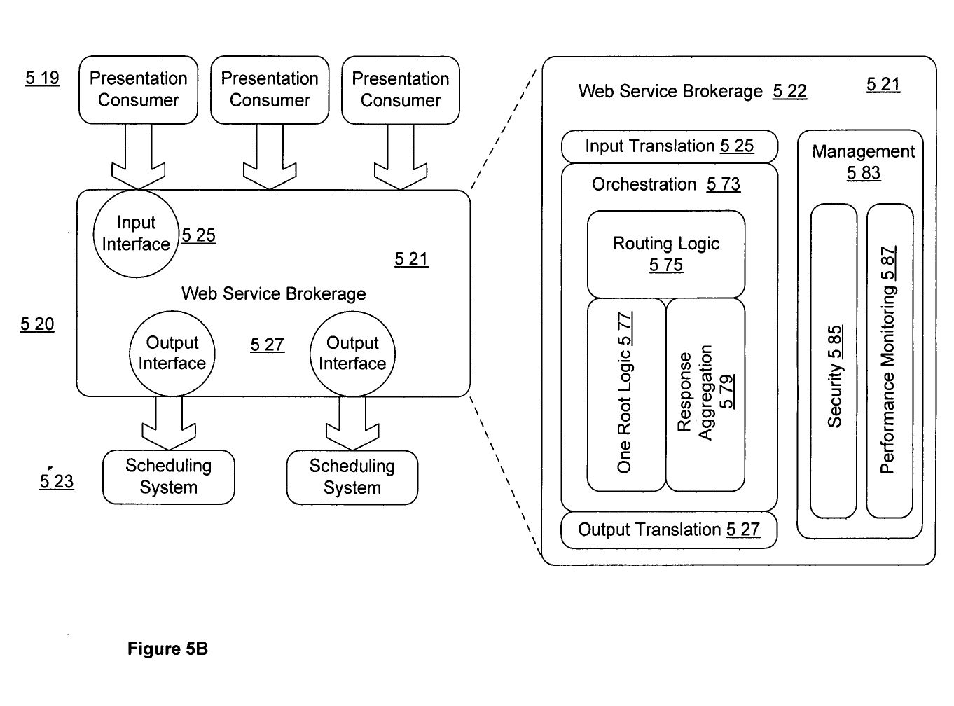

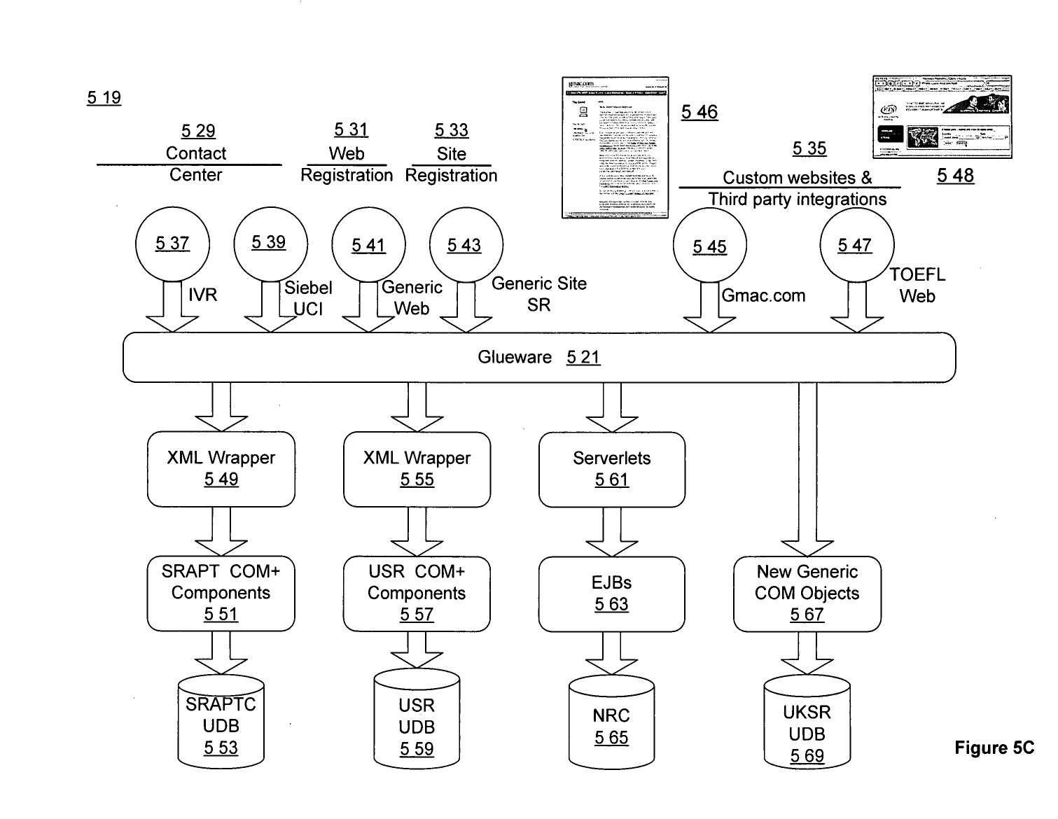

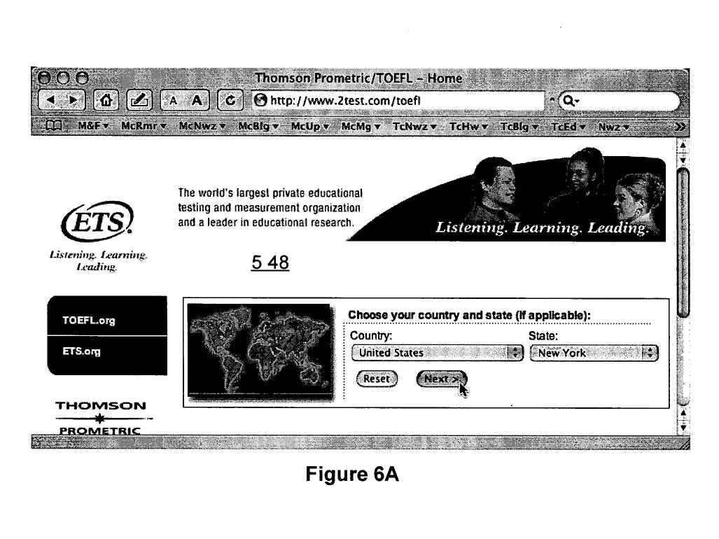

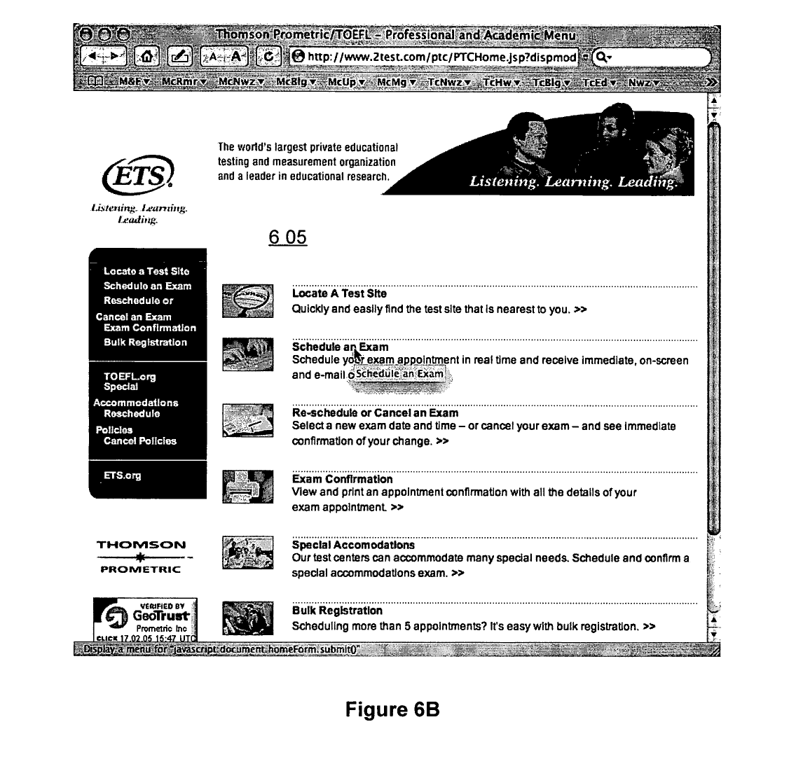

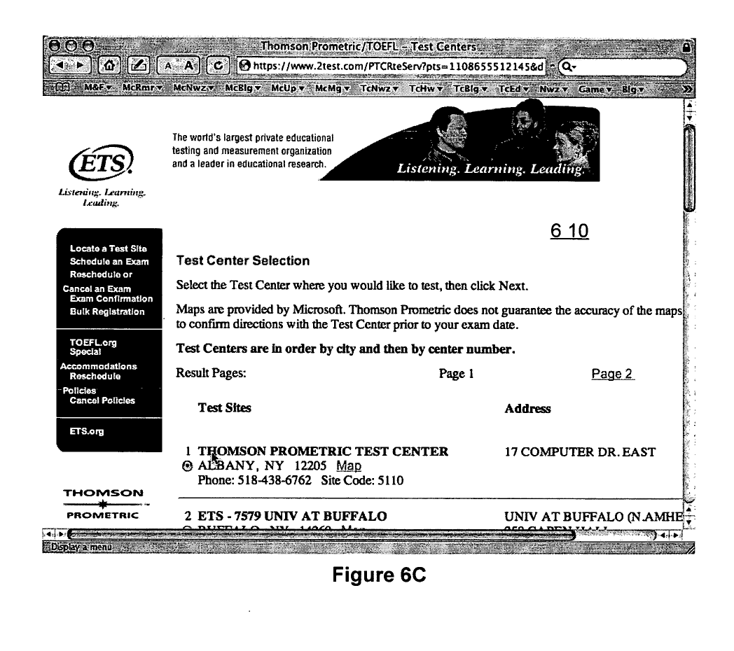

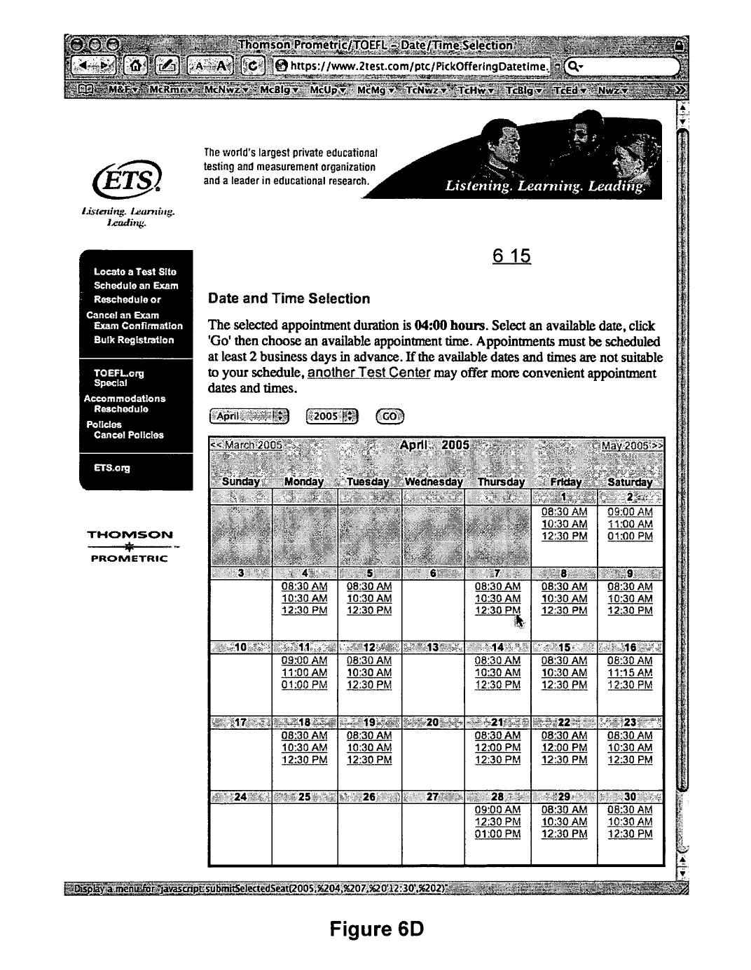

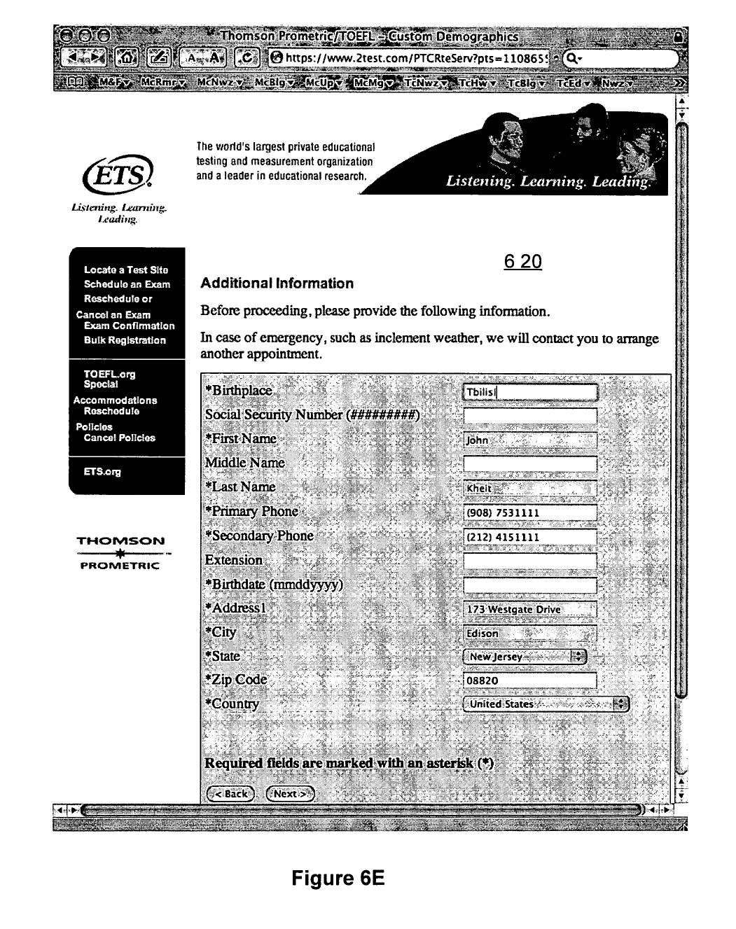

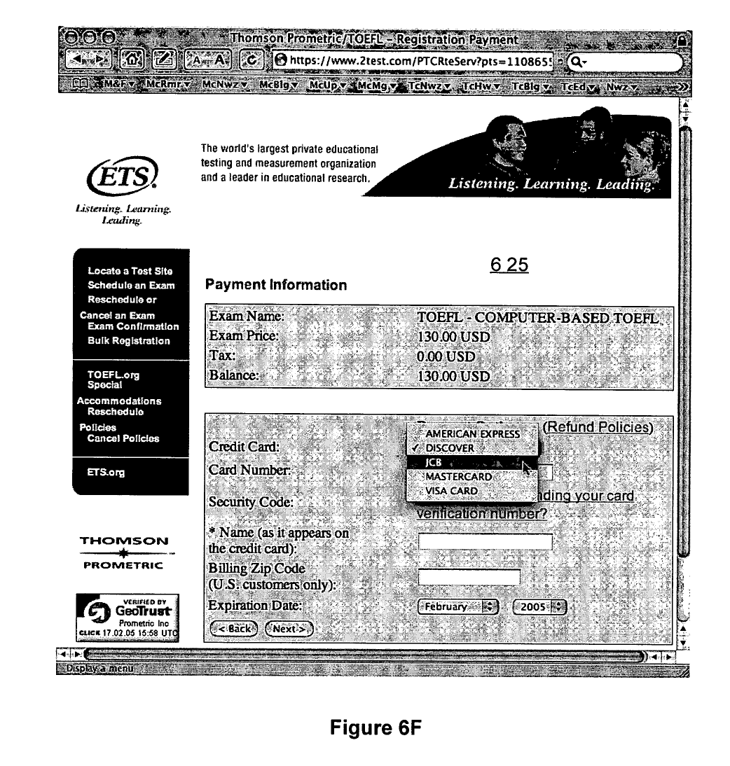

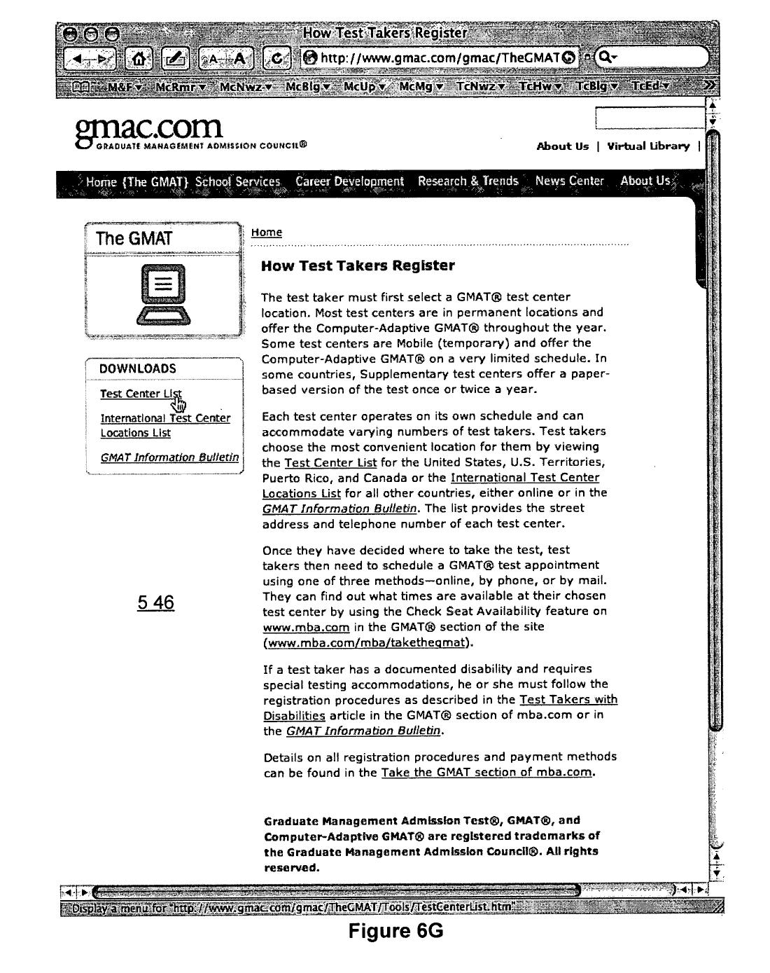

A Demand Test Facility Provider System (DTFPS) is comprised of several components which include capacity planning (FIG. 1), test candidate scheduling (FIG. 2), test generation (FIG. 3), test results processing (FIG. 4). FIG. 5 shows an example structural architecture for the DTFPS. The DTFPS allows for rapid and dynamic allocation of testing facilities and administration of tests. It should be noted that dashed boxes are indicative of optional embodiments. Further, solid lines indicate logic flow, while dashed arrows indicate data flow.

Capacity Planning

FIG. 1 is of a mixed data and logic flow diagram illustrating embodiments of capacity planning for the DTFPS. In one embodiment, the DTFPS is comprised of several and often concurrently operating components. FIG. 1 shows two of those components. The first component updates the Test & Facilities Database (TFDB) with regard to a testing facility's availability 137 (the “DB update component”). At the same time, the DTFPS' second component can provide matches 120 for requests for testing facilities (the “match component”). Generally, data flows between four actors: the testing authority 101, a testing provider 102, a test facility 103, and a test candidate (204 of FIG. 2). The testing authority is a body having the credentials and authority to conduct testing over a pool of candidates. For example, a state bar is a testing authority with the right to test candidates interested in practicing law. The test provider is a service provider arranging for the administration of testing. The test provider offloads the logistics of test administration from the testing authority and coordinates with test facilities 103, candidates 104, and the testing authority 101 to provide the administration of various test events. Various components of the DTFPS take on the role of a test provider enabling the administration of a wide spectrum of tests for different groups of people. Ultimately these various types of tests are offered and required of candidates. The candidates in many instances must qualify to sit for the tests. The test provider, e.g., the DTFPS, enables candidates to schedule tests, provides facilities for the actual test, collects and may grade the results, and may reports the results to the testing authorities and candidates.

Before moving on with the description of these two capacity planning components, it is worthwhile to describe the various types of testing facilities in greater detail. In general, the TFDB tracks three different types of testing facilities: fixed, temporary, and mobile. Fixed facilities and/or long-term facilities are stationary and continuously available; such facilities may be available all year round for regular intervals. Fixed facilities generally have much of the testing infrastructure (i.e., testing materials and/or equipment) operationally in place on a continual basis. Testing materials and equipment may include: proctors and/or test administrators; test-taker monitoring equipment (e.g., parabolic mirrors, video cameras, VCRs, etc.); actual test materials (e.g., physical print-outs of tests, scrap paper, pencils, etc.); physical seating furnishings (e.g., chairs, desks/tables, etc.); computers equipped with test taking software allowing candidates to take tests electronically; printers; communications equipment for connecting computers to a DTFPS (e.g., routers, switches, network cards, software to enable communications with a remote DTFPS, etc.); a communications connection to a communications network like the Internet (e.g., satellite, LAN, cable, telephony, cellular, WiFi, etc.); a source of energy (e.g., outlets within structures, generators, extension cords (for access to electricity from nearby structures in cases of mobile testing facilities), etc.); and/or the like. It should be noted that physical print-outs of tests, in practice, are not made for security reasons. The addition of an option to print-out a physical test is provided to demonstrate this possible application should a testing authority desire such a test administration; for example, should generator power be diminished in a mobile test center such that it is not sufficient to last for the administration of a test event and if an alternative source of energy for the electronic test terminals is not found, then administrators could have the option of printing tests prior to the depletion of the generator's fuel if the testing authority authorized the printing in such circumstances.

Temporary facilities are stationary, but are available for testing only for specified and agreed upon intervals. Often facilities with excess capacity may serve as temporary facilities. For example, many schools have classrooms and/or other physical plants that are unused outside of normal operating hours and/or during certain off-season timeframes (e.g., summer break at public high schools). The temporary facilities are not typically fully equipped for providing testing facilities. As such, prior to a scheduled testing event, testing materials and equipment may be brought and set-up on such premises, and removed after the testing event concludes.

Mobile facilities may also be used for testing facilities. In one embodiment, a mobile home, bus, truck tractor-trailer, recreational vehicle, van, etc. may be furnished with computer clients, network connectivity, seating furnishings, and/or other materials required for providing testing facilities. Such mobile testing facilities may be deployed to remote areas as needed.

Although three general types of testing facilities are described, it should be noted that numerous hybrid and/or other forms of testing facilities are contemplated and may be employed by the DTFPS. For example, it is possible to have temporary mobile facilities wherein testing materials and/or equipment are outfitted on a mobile facility and deployed in a location requiring testing services. Upon conclusion of the testing, the testing materials and equipment may be removed from the mobile facility, and the mobile facility may be returned and/or used for other purposes.

Moving back to the description of capacity planning and its components regarding facility availability updating, a test provider's system, e.g., DTFPS, may generate a request for the availability of various testing facilities 139. The TFDB 119 has a table storing information regarding all known testing facilities. The TFDB 119 maintains various attributes 138 regarding each test facility such as: facility size, seating capacity, availability type (e.g., continuous, fixed, mobile, seasonal, temporary, etc.), availability dates, availability times, cost of facilities for time spans, available materials and equipment, operation metrics, and/or the like. However, it should be noted that test provider personnel may generate requests for facilities not in the TFDB. This is particularly germane when there is no further capacity and personnel are aware of facilities with which there is no relationship. For example, if a particular region requires a test center and there are no facilities there, personnel may identify alternative premises in the area through investigation (e.g., yellow pages). Another example might cause the DTFPS to recommend the purchase and/or rental of mobile facilities, e.g., a van, to increase facility capacity for a region.

In one embodiment, the TFDB table of testing facilities may be expanded and/or updated by generating a request for facilities to provide additional testing availability 139. The request may include a number of characteristics 137 to describe upcoming requirements for test facilities. In one embodiment, a Web form is used to specify the requirements, which in turn generates an email request for one or more testing facilities. The email request may provide a URL link, which when engaged, will access the DTFPS' Web server, which in turn is connected to the TFDB. As such, a user receiving the URL link will be able to update information in the TFDB 119 regarding the test facility's availability and attributes. The request may specify any number of attributes that users at the testing facility will be specifically asked to update. For example, a capacity planning request may comprise an XML tag delineated request specifying the following attributes:
<seating>100 candidates</seating>
<test date>Nov. 11, 2005</test date>
<test time>11AM thru 3PM</test time>
<connectivity>T1 Ethernet</connectivity>
<equipment>100 PC terminals with DTFPS connectivity software</equipment>
<proctors>4 adults</proctors>
<location>07060</location>
<location radius>50 Kilometers</location radius>

Requests may be targeted to all testing facilities, to geographical regions, to specific test facilities, and/or the like. For example, a DTFPS Web form may allow the specification of a singular testing facility, should the test provider's capacity planning personnel have such a need. It should be noted that basic data input verification may be employed to prevent creating requests that are likely to be unmet. For example, if a given facility has only a total capacity of 50 seats, a request for 100 seats would be flagged as outside the range. This may be achieved by reading the attribute record for a given facility from the TFDB upon selecting the testing facility in a pop-up menu on the Web form. However, such known limits may be overridden as facilities are upgraded from time to time, and as such, the request may serve as an opportunity for the facility managers to update the TFDB attributes record. It should be noted, however, that typically requests 139 are targeted at geographic regions, and as such, verification of input ranges may skipped. Nevertheless, even with wide geographic ranges, and/or no limits, the DTFPS may perform basic selects based on a test provider's request criteria. For example, if a test provider specifies seating requirements of 5,000, and no single testing facility in the TFDB has such capacity, the DTFPS may flag this lack of capacity with an error message.

In this manner, the DTFPS may select all testing facilities from the TFDB as specified by the request and generate a request for each facility 139. Typically, the testing authority will require testing facilities within a specified geographical region. As such, the request may include a location designation, and a radius about the location within which the facilities may reside. The DTFPS may accommodate such requests in several ways. In one embodiment, a zip code is supplied specifying the location. In an alternative embodiment, a longitude/latitude coordinate pair is provided. Various software products are available to calculate if ranged selects based on the location and location radius match request criteria. For example, ArcView from ESRI allows a user to supply a zip code and radius, and it outputs a range of zip codes that geographically fall within the supplied radius. As such, the DTFPS may then select testing facilities falling within any of the output zip code ranges. Thus, the DTFPS may select all testing facilities within the geographic scope of the request 139. It should be noted that the calculations returned from ArcView may form part of the SQL query embodiment of the users request 139. In one embodiment, Microsoft XQuery and Xpath are used for Web services and XML document querying and/or parsing. In general, user (e.g., capacity planning personnel) selections in the Web form are used as constrains and populate and act as constraints in an SQL query that form the facility availability request 139. It should also be noted, that instead of a Web form, users may make direct queries and/or entries in the DTFPS as a way of generating the availability request 139.

Upon generating the request 139, a record of the request may be queued and/or stored in the TFDB 119. The test facility receives notice of the request for availability 141. An authorized user at the test facility 103 may generate a response to the request in a number of ways 145. As mentioned, in one embodiment, the test facility receives an email with a link allowing it to provide responses 145 to the request directly to the DTFPS and TFDB by way of a Web server and Web form. In such an embodiment, the Web form may provide any of the testing facility's attributes 138 in the form and allow editing by the authorized user. The form can retrieve the appropriate test authority attributes record from the TFDB by supplying an appropriate testing facility identifier. Similarly, for purposes of authentication, the DTFPS Web form may require a user and password from the test facility user prior to allowing any access. In another embodiment, the test facility receives an email with a textual inquiry regarding facility capabilities and the user may respond by replying to the email. Such emails may be sent to a designated contact point (e.g., by way of reply-to address in the request 139 email) where they are parsed. In one instance, the user is instructed to reply to the email by placing answers after textual prompts in the email that act as parse tokens. In another embodiment, data entry personnel at the test provider read the email and enter the answers into a request response record that is saved to the TFDB.

Upon generating a response 145 to the request 139, whether by Web form 138, email, and/or otherwise, the response regarding availability is provided to the DTFPS' Web server and ultimately queued and/or stored in the TFDB 150. As queued responses are processed and testing facility records are updated in the TFDB 119, future inquiries to the DTFPS regarding test facility operations will benefit from the updated information. It should be noted that such requests 139 may be generated at regular intervals, for example by generating generalized information update requests from the periodic instantiation via a UNIX cron job.

Quite often, however, demand for testing facilities is generated 105 by candidate applications for tests and test facilities. In instances where the supply of testing facilities is insufficient (based on then current TFDB information), such requests for testing facility availability 139 may be generated. As such, the requests may uncover new capacity supply availability. In one embodiment, requests may be sent with solicitation offers. Such solicitations may include monetary offers for facilities that may vary from contracted terms on file. For example, if a contract terms for a facility provide $10 per candidate seat per hour of testing, and if a test authority contract requires testing when capacity is not otherwise available, a solicitation may include an offer of $15 per candidate seat per hour of testing as an enticement for testing facilities to open up extra capacity.

Moving to the matching component 110 of the DTFPS, a testing authority 101 may generate a request for the administration of a testing event 105. The testing authority may dictate that several test events are to take place at specified times throughout a year and provide various requirements 107. Testing requirements may include: a date of exam, registration dates for the exam, a list of geographic regions (e.g., cities, zip codes, etc.), number and/or list of authorized candidates, candidate information (e.g., name, address, candidate ID, age, etc.), type of testing facility (e.g., fixed, temporary, mobile, etc.), time span for testing (e.g., 3 hour long administration), dates of the testing events, operational metrics, and/or the like 107. Although the requirements may include numerous simultaneous geographic sites for test administration (each having candidate and metric requirements), for sake of eased comprehension, we will use the example of a single region and test event site. However, it should be noted that the complexity of the requirements can increase significantly and the DTFPS may service such complex requirements with equal facility. In one embodiment, the request is generated through a Web form allowing for the entry of test event requirements 105, 107. In an alternative embodiment, authorized test authority personnel may contact the personnel of the test provider and relay test event requirements (e.g., via email, telephone, in person, etc.), which would be entered into the DTFPS via subsequent data entry.

Upon receiving the request for testing 105, the DTFPS searches the TFDB for available test facility resources that match 110 the test authority's requirements 107. This may be achieved by composing an SQL query based on the supplied requirements 107. For example, the testing authority may provide the following tag delineated request:
<location>07060</location>
<seating>300 candidates</seating>
<test time>11AM thru 3PM</test time>
<test date>Nov. 11, 2005</test date>

This may be parsed into the matching TFDB table and field tokens for search and selection resulting in an SQL query similar in construct to the following example:
Select Test_Site.location, Test_Site.capacity,
Test_Site.availbility_date From Test_Site in
((Having Val (Test_Site.capacity) >=300) in
((Having Val (Test_Site.location) =07060) in
((Having Val (Test_Site. availbility_date)=Nov. 11, 2005);

The query may be supplied to the TFDB for testing facilities matching the request 105 requirements 107. If no matches result 115, then the DTFPS may generate a request for test facility availability that might fulfill the request requirements. If upon iteration matches still fail to materialize, the DTFPS may provide the searches that come closest to matching the request. In one embodiment, the DTFPS may combine multiple facilities to service a testing authority request. For example, if a testing authority requests 10,000 seats for a testing events and no single testing facility is available with such capacity, the DTFPS may aggregate multiple test facilities that otherwise match the request 105 requirements 107 as a way to satisfy the test authorities request 105. This may be achieved by changing the SQL query to aggregate values for a given attribute (e.g., aggregating for Test_Site.capacity).

If the DTFPS returns matches 115, the DTFPS may list 120 the best matches for review and/or approval 125 by test provider personnel. In one embodiment, the DTFPS automatically approves matches with the lowest cost structure 125. If no matches are approved 125, other matches 115, 120 are reviewed until one is approved or if no matches remain, a request for more suitable facilities may be generated 139.

Upon approval of a match 125, the DTFPS generates contracts for facilities based on the matching requirements 107, 130. In one embodiment, legal contract templates are designed with form entries. The DTFPS may then retrieve the best match's facility information from the TFDB. For example, the DTFPS may retrieve the owner/authorized agent's name, contact information, rates for facilities, and use specified requirements to fill in form elements providing a rough draft for the test provider's lawyers. If the testing facility is already under a contract for a continuous period of time, contracts do not need to be drawn, and work order similarly is generated 130. Upon executing the contracts and/or receiving confirmation regarding the work order 130, the testing facility's TFDB record is updated reflecting its unavailability for the specified 107 times. In one embodiment, upon approval 125, the testing facility's TFDB record may be provisionally updated reflecting its impending unavailability 135, which would make it a lower ranked match 120 in subsequent searches 115. In one embodiment, if new facilities need to be established 133, operations personnel are instructed to develop the new facilities as per the generated work order 130.

Scheduling

FIG. 2 is of a mixed data and logic flow diagram illustrating embodiments of candidate test scheduling and facility demand creation. FIG. 1 illustrated that a testing authority 101 may generate a request for a testing event 105 and specify requirements including the number of candidates that wish to take the test. Often, however, the actual number of candidates wishing to take the test are not known. In such instances the testing authority is providing estimates or operational metric requirements regarding capacity. Operational metric requirements are requirements specified by the testing authority for a given testing event. For example, a testing authority may specify that the test provider must provide enough testing facilities so that 95% of candidates are within 25 miles of a testing facility. However, at the time when test authority generates a request for a testing event 105 candidate registration for the testing event may still be open. As candidate registrations are incoming 205, the DTFPS may need to reevaluate available capacity and metric requirements. As such, FIG. 2 illustrates how demand is created by candidate registrations and how when extra capacity is required, the DTFPS' components in FIG. 2 can trigger requests for extra capacity employing components already discussed in FIG. 1, 105. Further, when a test authority generated a testing event 105, it was saved to the TFDB.

In one embodiment, a candidate applies to take a test by providing credentials 205 for test registration to a testing authority 210. In an alternative embodiment, the credentials may be provided to a test provider 102. In either case, upon obtaining the credentials 210 and screening the candidate for approval for testing, a candidate ID and other test information is provided to the candidate 215. When the candidate ID is generated 215, a candidate record is generated and stored the TFDB 119. Once the candidate obtains a candidate ID 220, the candidate may then schedule to take an instance of the test. In one embodiment, initial registration 205 is sent to the test authority/test provider via hard copy and data entry provides it to the TFDB 215. Similarly, the candidate may receive their registration information and candidate ID via hard copy (e.g., US mail). In another embodiment, registration information is emailed to the candidate. In still another embodiment, the candidate may visit a Web site and register via an online Web form 225. Via Web form, the user may select the type of test, location, desired test date, time, and/or the like 230, 231. In generating a scheduling request, the candidate also enters their candidate ID 236, payment information, and/or the like 236. Once this information 235 is submitted, the DTFPS stores the scheduling request and information in the TFDB 240. The candidate record that was created earlier 215 is matched with the supplied information, e.g., the candidate ID.

In one embodiment, the DTFPS continuously checks for availability and capacity based on ongoing candidate scheduling requests 245. Availability checking 245 may take several forms. In one embodiment, availability is only checked upon the close of registration for test. In another embodiment, availability is checked periodically, e.g., via UNIX cron iteration, and/or the like. In another embodiment, a set number of candidate scheduling requests 235 will trigger an availability check 245, e.g., every 100 scheduling requests. In yet another embodiment, every scheduling submission triggers an availability check 245. In cases where an availability check 245 is not immediate, scheduling requests 235 are queued and stored in the TFDB and the queue is examined on the subsequent trigger event. Once there is a check for scheduling availability 245 as requested 235 by the candidate 204, a search of the TFDB takes place to determine if the candidates requested locations, times, etc. can be met. The DTFPS generates a query based on the candidate's request 235, and if a match is found 245, then the DTFPS schedules the candidate by decreasing capacity at the selected testing facility by one, charging payment, and generating confirmation reports. In the case where availability is not immediately determined 245, the confirmation reports are mailed to the user for review 250. In the case where availability determination is immediate 245, the confirmation report may be displayed on the user's Web browser in a Web page or emailed 250. If the DTFPS determines that the candidate's request cannot be met 245 and there is a lack of testing facility capacity/availability, then the DTFPS may determine if there is a need to schedule more facility capacity 255. In actuality, a determination if more capacity is needed 255 may also be performed after scheduling a candidate 250. One reason is if capacity at testing facilities is reaching a maximum, the DTFPS may determine that more capacity is needed before there is an actual shortage of facility capacity. It should be noted that in another embodiment, such capacity analysis is based on a set of reports that are generated after the scheduling has taken place. For example, the reports may be generated on a monthly basis and do not need to be connected to the scheduling system.

The DTFPS may use any number of heuristics to determine if more capacity is needed 255. In one embodiment, if there is any lack of availability 245 resulting from candidate scheduling requests 235, or anytime maximum capacity for a testing facility has been reached by the scheduling of a candidate 250, then more capacity is sought out 255. In another embodiment, rates of scheduling are observed. For example, the DTFPS may track that a particular location is experiencing 30 registrations a day with 30 days remaining until registration closes for a test site. If that test site only seats 750 candidates, there will be a capacity shortage, and as such, the DTFPS may determine that more capacity should be sought 255. In another embodiment, operational metric requirements 107 specified by the test authority may dictate capacity allotment. For example, if there is a requirement that 95% of candidates are no more than 25 miles away from test facility and 50% of applying candidates are further than 25 miles away from a test facility, the DTFPS may determine that more capacity should be sought that provides better coverage. In such an example, the DTFPS may use ArcView to find zip codes that would provide coverage rot that 50% of applying candidates so they would not have to travel more than 25 miles. This may be achieved by retrieving the address of each non-served candidate and querying the ArcView system. As each non-served candidate's zip code is examined, the distance of that candidate's zip code is measured to all the other non-served candidates. In this manner, it is possible to narrow down a range of candidates that will serve the non-served candidates. In some instances, more than one zip code/location will have to be used to satisfy the operational metrics.

If the DTFPS determines that more capacity is unnecessary 255 and if there was no availability as requested 235 by the candidate, then the DTFPS may determine if there are alternatives for the candidate 260. For example, if the location of testing selected by the candidate is at maximum capacity, the DTFPS may locate alternative locations offering the required test on the same date. If alternatives exist 260, the DTFPS may present them to the candidate 270. In one embodiment, the candidate is informed of lack of availability 245 and with a Web form allowing the candidate to select the provided alternative locations, dates, times, etc. 270 and submit that request to the DTFPS 240. Should there be no alternatives 260, the candidate may be presented with a message that they may have to reregister for a test administration at a later date for which there is no current scheduling information. Alternatively, if the DTFPS determines more capacity is needed 255, it can generate a request for more capacity 286 as already discussed in FIG. 1, 139.

Test Generation

FIG. 3 is of a mixed data and logic flow diagram illustrating embodiments of test generation 320 and provision 380. Ultimately the DTFPS enables candidates to take tests at test facilities on behalf of a testing authority. To that end, upon receiving confirmation instructions 250 of FIG. 2, the candidate 204 will arrive at the scheduled test event at the proper test facility. In certain instances, the tests are provided electronically. In such instances, once the test facility has been set up with the proper equipment and communications channels, the electronic testing terminals may generate a request for a test for the given test event 355. The terminals may supply a test specification 360 as part of the test request 355. The test request specification may include: a test center ID (i.e., uniquely identifying the test facility), test ID (i.e., uniquely identifying the type of test), student ID, test date, test time, test location, test terminal ID (if any), and/or the like. It should be noted that not all the request parameters are required for every test. In one embodiment, this specification is stored on each electronic test terminal. In most cases a test ID will suffice. The request specification may be stored in XML format. The electronic terminal may determine if there is a test already on the client 265. If it is already available, the electronic testing terminal is ready to provide the test to the taker 380 and may enable test taking at the proper time. However, if the test is not on the client or if the test is not current 365, the electronic test terminal may generate a request for the test and send it to a test publishing group, e.g., DTFPS 302. The electronic test client may generate a query for the TFDB using the test center ID, the test ID if a test is stored on the terminal, a candidate ID, and/or the like and compare the test ID of the test on the terminal to those appropriate for the terminal; e.g., determining that it is the proper exam type for the time of day, location, and candidate. The DTFPS may use the test center ID and the time the request was sent to search the TFDB 119 for the right test to supply back to the electronic test terminal. In addition, the candidate ID and other information may be used to further identify the test that should be supplied to the terminal. Once the DTFPS identifies the appropriate test, it provides it to the electronic test terminal 375, which in turn provides the test to the candidate for execution 380.

While test facility request generation takes place 355, the DTFPS may independently determine if electronic testing terminals need updating 340. If the DTFPS determines that the test on the electronic testing terminal at the test facility needs to be updated 340, then the DTFPS can query the TFDB for a new test 350. In one embodiment update polling and transfers as between the DTFPS and electronic testing terminals may be performed using Microsoft Message Queue. The message queue on the DTFPS may then poll the clients, i.e., the electronic testing terminals, for updates. It should be noted that the message queue can update any specified components on the client, and is not limited to just updating tests. The updates may be specified by a service script that provides instructions by way of XML commands for how to update exams, the administration system and/or other components. In one embodiment, Distributed Component Object Models (DCOMs) control the execution of such XML commands and XML DOMs enable the reading of configure files and execution through late binding. Once it identifies an appropriate test, the DTFPS can provide the test to the electronic test terminal based on its test center ID 350. Even if there is no need to update the test 340, if a request for a new/updated test is received by the DTFPS 345, the DTFPS can update the requesting client 350. If no update was requested 345, the DTFPS can continue to check if updates are needed 340. It should be noted that this iteration 340, 345, 350 may be engaged periodically, e.g., via UNIX cron, run continuously, and/or on demand based on requests 370.

The TFDB's test data item bank and test specifications can be provided by a test authority 305. In an alternative embodiment, test materials are purchased from third parties. In yet another embodiment, the test provider supplies such materials. Regardless of who provides the test specification, a test specification is generated and provided 305 to the DTFPS. The specification may include any number of testing requirements. In one embodiment, the test specification is in XML format and may include: a test ID, a test authority ID, a series of questions (e.g., a list of questions, false answers, and correct answers), test type descriptors (e.g., essays, short answers, multiple choice, simulations (e.g., which may include a computer driving simulation program and hardware requiring the candidate to engage in simulated driving), etc. and instructions for each such section type), an algorithm for test composition (e.g., the number of each type of question, the difficulty of questions and distracters, the numbers and placement of difficult vs. easy questions, etc.), a grading algorithm, and/or the like 307.

Example test assembly algorithms may include:
Random: this randomly selects a specified number of questions for a given type of question (e.g., 5 random questions from a pool of 100 multiple choice questions).
Random Random: this randomly selects the number of questions to comprise a type of question, and then randomly selects a specified number questions for that type of question (e.g., the DTFPS decides the multiple choice section will have 30 questions, and then randomly chooses those 30 questions out of a poll of 100 questions). Another example would be to have 10 random sections with 10 random questions each.
Random Random Random: this algorithm is more concerned with time and difficulty levels. As such, it may hold for an overall specified examination length and difficulty level. If that were the sole constraint, then the DTFPS may decide to provide any random type of question. For example, the DTFPS may randomly decide to have only essay questions that take 1 hour to answer, and then randomly select essay questions from a pool averaging their difficulty level. It should be noted that questions may have associated metadata, e.g., each question may have a difficulty rating associated with it (for example ranging from 1 (easiest) to 5 (most difficult). Alternatively, the DTFPS may randomly decide to provide 10 short answers, 50 true and false questions, for the same 1 hour time frame. The variables are numerous in that a large number of easy questions in a short amount a of time may create greater difficulty. Similarly, a single yet extremely difficult essay question may also satisfy the difficulty and time constraints of the algorithm.
Sequential: this algorithm observes question dependencies. For example, the algorithm may require that in order to ask a question of form C, it must first ask questions A and B. Here, question C may be an essay that depends on information provided in a reading comprehension paragraph for multiple choice questions of type A and short answer type B questions.
Adaptive: this algorithm starts with questions of middle difficult and increases subsequent question difficulty for each question answered correctly, and decreases subsequent question difficulty for each question answered incorrectly. Such tests are useful for establishing a performance level relative to past aggregate scores.

Numerous other test types exists and it is possible to combine the above algorithms into new forms. For example, one may combine random and adaptive algorithms. In such an embodiment, the DTFPS will supply the test taker with questions at random but monitor the number of questions the test taker gets right and wrong at various question difficulty levels; such an algorithm could terminate once it determined areas where the test taker was proficient and difficult levels where the test taker was not proficient.

Once the DTFPS receives the test specification 305, it parses the specification 310 into its constituent parts by matching XML tokens from the specification 307 to matching field types in the TFDB. For example, the test ID is used to uniquely identify the test type and acts as a key field in the test data item bank table. Similarly, the test questions, distracters, correct answers, etc. may be stored in the test data item bank. The test specification's question allocation algorithm may be stored in a TFDB test specification table and also uniquely identified with a test ID. Once the test specification is parsed into its constituent parts 310, those parts may be stored into the TFDB 315. As a consequence those parts become searchable. As such, the DTFPS may retrieve the test generation algorithm from the TFDB based on a test ID and use that to query for specified numbers of questions. For example, the test algorithm may specify that a test is to comprise 6 essay questions (e.g., 2 being easy, 2 being moderately difficult, and 2 being difficult), and 50 multiple choice questions (e.g., 20 being easy, 20 being moderately difficult, 10 being difficult, and 50% of all questions are to have at least one distracter). The algorithm may be embodied as an SQL query; the algorithm query stored in the TFDB, is retrieved when needed and executed as a query on the TFDB on the test data item bank for matching test questions. Such retrieval of a test generation algorithm and search of the TFDB based on the algorithm query, results in the generation of a test 320. The resulting tests may be likened to a report resulting from the test generation algorithm. One or more tests may be generated as is desired. The generated test 320 is submitted for approval 325. In one embodiment, the test is provided to the test authority for review and approval, e.g., via Web form, email, etc. If the test is rejected, the DTFPS may iterate and generate more tests 320. The approved tests 325 are supplied to a queue to update and store tests to the TFDB 330. These stored tests may then be retrieved as already discussed 350 based on a test ID, test center ID, etc. In another embodiment, no approval is necessary, and each test candidate takes a randomized test. The candidate's personalized test is then saved along with the candidates answers, and various grading algorithms may be applied to the candidates test, including curve grading based on question difficulty and on the performance of others that have experienced similar questions.

Test Result Reporting

FIG. 4 is of a mixed data and logic flow diagram illustrating embodiments of test grading and reporting. After a test is provided to a candidate and the test is completed 380 of FIG. 3, the electronic test terminal sends the test results to the DTFPS 455. In one embodiment, the results are formatted in XML and include: a test center ID, a test ID, a test number, a test center ID, question ID, answer, and/or the like 460. The DTFPS receives the test results 455 and parses the results similarly to the discussion of parsing in FIG. 3, 310. Once the test results are separated into constituent parts, the DTFPS uses the test ID, test number, candidate ID, etc. to store the results 420 to the TFDB. If test results are being sent piecemeal 455, the DTFPS will determine if the test is complete 425. For example, the test results may include a flag that more results are to follow. In another embodiment, the electronic testing terminal may send 455 a current count and a total number of questions value that allows the DTFPS to determine if the test is complete 425. If the test is not complete, the DTFPS will continue to receive and parse results 415 until the test is complete 425. Once the test is complete, the DTFPS generates a test report 430. In the case of multiple-choice test questions, the DTFPS can generate a score identifying the number of correct answers attained by the candidate and store the results to the TFDB. In the case of essay questions, the DTFPS may provide the answers in full for graders. Once the test results are generated 430, they are provided to the test authority 405. In one embodiment, a test report is sent to the candidate as well.

Numerous scoring algorithms may be employed; examples include:
Pass/Fail: this algorithm requires that a certain number out of the total number of exam questions must be answered correctly.
Sum: this algorithm simply adds up the total number of correct answers relative to the total number of questions asked.
Weighting: this algorithm can weight certain sections and questions differently from others. For example, questions of higher difficulty may be weighted higher when answered correctly and less when answered incorrectly. Different sections may have different weights as well. For example, an essay section of 2 questions may be weighted higher than a true/false section of 50 questions.

It should be noted that numerous other grading algorithms may be used and that combinations between the above algorithms (as well as with other algorithms) is contemplated by this disclosure.

Demand Test Facility Provider System Structure

FIG. 5 is of a mixed data flow and structure diagram illustrating embodiments of the DTFPS.

Architecture Components

In one embodiment, the DTFPS employs components with XML stacked technologies 503. The stack may comprise a Hypertext Transfer Protocol (HTTP) 517, which is one of the basic transport protocols used on the Internet. It manages the ‘getting’ and ‘posting’ of data between systems. Web browsers use this protocol for moving data between client and server; Extensible Markup Language (XML) 515, which is a mechanism allowing for the creation of self defining data by “tagging” elements of the data with names and other metadata to describe the elements; Simple Object Access Protocol (SOAP) 513, which is a lightweight XML-based messaging protocol used to encode the information in Web service request and response messages before sending them over a network; and Web Service Definition Language (WSDL) 511, which is a XML language that contains information about the interface, semantics and “administrivia” of a call to a Web service. Example tools for the HTTP, XML, and SOAP layers include Apache and/or Microsoft Internet Information (IIS) Web server products.

Such a core Web Services component approach enables multiple business units to integrate their products together into a homogeneous solution for enterprise customers. The use of Web Services allows for the integration and interoperation of the scheduling and registration systems of the DTFPS. Another advantage of this structure is it allows the building of Web Services that separate the interface of the DTFPS from the business logic and application of the DTFPS. This allows for an abstraction where the consumer/user of a Web Service does not require any knowledge of its implementation, only the details of the interface are required. This enables the creation of loosely-coupled applications that are only defined by the points at which they interface, rather than at an underlying implementation or data model level. The defining concept of loosely-coupled is the protection of other parts of a distributed system from changes in an individual node.

Architecture Layers

As an example, Consumers A and B 505 may use a Service A 507, this in turn may use Services B and C 509, all without needing to know or account for the various services. When the DTFPS is implemented using a loosely coupled service orientated architecture, then it is possible for example to change the functionality of Consumer A without any impact to Consumer B, and perhaps more importantly to change the implementation strategy for Service B or C without the need to alter either Consumers.

Moving from the more generic abstract, one such DTFPS structure may be shown as having three generic layers: a consumer presentation layer 519, a Web Service (i.e., Brokerage) layer 521, and a business logic (i.e., scheduling system) layer 523. The interfaces between the Presentation Consumers 519 and the Brokerage layers 521 may be implemented using loosely coupled web-service interfaces. As will the interfaces between the Brokerage 519 and the Scheduling Systems 521. In other words, each of the layers will use the aforementioned technology stack as the bases for Web Service interaction.

Brokerage Layer

In one embodiment, the DTFPS employs a Brokerage layer 521 that may provide multiple services. For example, these services can be grouped into three categories; Translation 525, 527, Orchestration 573, and Management 583.

Translation Services

The translational services 525, 527 are responsible for accepting data and translating it into 525 a form usable by the Brokerage layer 521, and also for generating output 527 in a form that is usable by the Scheduling System 523. As such, the translation services 525, 527, provide an interface 521 as between the Presentation layer 519 and the Scheduling System 523. Translation services may be used to enable different presentation layer and business logic layer interfaces to be exposed to the different consumers and service providers. For example the same presentation layer may make scheduling requests to two different scheduling systems without implementing the scheduling protocol used by either scheduling system. This is the loose coupling that was discussed earlier.

In one embodiment, by using the technology stack 503, the presentation layer 519 provides information in an XML format by employing the HTTP protocol for transfer. As such, the Brokerage layer 521 need use minimal or limited parsing to obtain tokenized values from the presentation layer. Similarly by employing the technology stack 503 at the Scheduling System 523, XML may be employed throughout. However, it should be noted that where legacy systems may exist, the translation components 525, 527, may translate the input. For example, should the Brokerage layer 521 receive XML formatted input from a user, the output translation layer may convert the XML into tab delineated format (i.e., with tags being used as column heads describing a trail of comma delineated data values) if such is required.

The Oracle/Peoplesoft Integration Broker® (http://www.peoplesoft.com/corp/en/products/line/app_integration/appconnect/int_broker/ind ex.js), Microsoft BizTalk® (http://www.microsoft.com/biztalk/evaluation/overview/biztalkserver.asp), Actional SOAP Station® (http://www.actional.com/products/web_services/soapstation/index.asp), Sonic Business Integration Suite® (http://www.sonicsoftware.com/products/business_integration/index.ssp), and/or Grand Central Communications® (http://www.grandcentral.com/solutions/index.html) are examples of products that may be used for the Brokerage layer.

Orchestration Services

Another set of services provided by the Brokerage architecture 521 are Orchestration services 573, i.e., Business Process Services. These services allow for the rapid creation of new product offerings and provide the flexibility that is required to implement such features as One Roof scheduling 577. An example of an Orchestration service would be to provide the following capability: a presentation layer consumer may request to schedule an exam without knowledge of the Scheduling and Registration system that needs to be called to fulfill the request. The Orchestration service could provide a Routing Logic component 575 that would make the decision as to which Scheduling System 523 to route the request to, and ensure the response is routed to the correct requestor.

Another example of Orchestration Services 573 will be to provide One Roof scheduling 577, where the same exam is delivered in multiple testing networks, the Presentation Layer (for example Web Registration) 519 will request to ‘find a seat’ and then the Orchestration Services 573 will submit the request to multiple 575 scheduling Business Layers 523, the response from which will be aggregated and returned 579 to the Presentation Layer as one homogenous list of available electronic testing terminals.

As such, once the input is received in proper form 525, a request may be parsed. The request, e.g., “find a seat” would also contain the Presentation Consumer identifier (presentation ID) 519, for when there are multiple Presentation Consumer components interfaced with the Brokerage layer 521. By providing the presentation ID along with the request, it allows the Brokerage layer 521 and its routing logic 575 to determine which are the appropriate Scheduling System components to receive the request. In one embodiment, this may be achieved with an XML paired list providing a mapping of <Request Type> and <Presentation ID> to <Scheduling System ID>, where the <Scheduling System ID> identifies the appropriate address to which the provided request may be sent. This allows the request to be forwarded to one or more Scheduling System 523 components. As the different Scheduling System components 523 start returning responses, they are received and translated 527 as necessary by the Brokerage layer 521 and aggregated 579. The responses themselves may be XML tagged with a <Scheduling System ID>, the requesting <Presentation ID> and any response tags, i.e., <Available Exam Terminal ID>, <Available Time>, etc. As such, the Response Aggregation component 579 may collate numerous responses 579 to numerous Presentation Consumer 519 requests. In one embodiment, the Response Aggregation component communicates with One Roof Logic component 577, wherein the One Roof Logic component can provide a list of all <Scheduling System ID>s required to complete a request. As such, the Response Aggregation component 579 may poll and/or wait for the remaining Scheduling System components to provide responses and/or poll them for a response prior to aggregating a final list and providing the list back to the Presentation Consumer 519.

Management Services

Each of the existing Scheduling and Registration systems 523 of the DTFPS may have custom Authentication and Authorization processes 585. The Management Services provided by the Brokerage may consolidate such processes into one consistent offering. The same is true for performance monitoring 587 and many other management functions that are handled separately today. Such consistency allows for “Learning Single Sign On” infrastructure where a single login is required for access to numerous Presentation Consumer 519 and Scheduling System 523 components 583.

DTFPS Architecture

Moving from the abstracted Presentation 519, Brokerage 521, Scheduling 523 system 520 to a more detailed DTFPS architecture 530, better illustrates the amalgamation of several existing presentation layer components into three base components (i.e., a contact center 529, Web 531 and Site 533 Registration, and Custom Web site and 3^{rd} party integrations 535). This design also has the flexibility to provide custom interfaces to 3^{rd} Parties 535 such as exam sponsors.

In FIG. 5, the Brokerage layer 521 has been shown as one monolithic product spanning each of the Scheduling Systems 523 and Presentation Layer 519 components. This portrayal may lead the reader to imagine the creation of one single enterprise-wide point of failure. This is not the case. By employing an object-oriented architecture, multiple and separate instances of the Brokerage layer may be instantiated to serve one or more of the Scheduling System components 523, as will be described in greater detail.

The disclosed Enterprise Architecture described results in reusable components of the Brokerage Architecture being created and then reused across multiple implementations. For instance, in the UK where Data Protection legislation prevents movement of data outside the European Union, a separate instance of the Transformation, Orchestration, and Management services would be used. But by implementing the same Architecture the same level of flexibility and supportability will be achieved, without the need to create custom software. Using such a federated approach to implementing this architecture allows the system to scale horizontally, and prevents the creation of one large monolithic point of failure.

In one embodiment Scheduling and Registration Enterprise Architecture 530 could be described by its characteristics, it: ensures the separation of Presentation Logic 519 and Business Logic 523; creates loosely coupled Web Service 521 interfaces; and implements a federated Brokerage solution to provide: transformation Services 525, 527, Orchestration Services 573, and Management Services 583.

Thus, in one embodiment of the DTFPS, the architecture includes four separate databases 553, 559, 565, 569 (i.e., the TFDB), as do four sets of middleware 549, 555, 561, 567 (i.e., the federated Brokerage 521 layer acting as “glue-ware”), and three presentation layer components (i.e., contact centre 529, registration 531, 533, and 3^{rd} party integrations 535). In an alternative embodiment, the federated middleware may be combined into single Brokerage layer, or into numerous combinations.

The TFDB

Similarly, the TFDB databases 553, 559, 565, 569 may be federated and/or combined in any number of ways. As the databases are comprised of a number of tables, these table components may be all combined into a singular-monolithic database, or distributed into a series of databases with greater granularity (e.g., a database per table). In one embodiment, the four databases 553, 559, 565, 569 in FIG. 5 contain similar types of information. The TFDB databases may store information relating to: call dispositional functionality, candidates' addresses, candidates' appointment schedules, candidates' demographics, candidates' registration, centralized service requests, test dates, test facility locations, and/or the like.

The TFDB system database components 553, 559, 565, 569 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Microsoft SQL servers may be used as well. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the TFDB system database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the TFDB system database is implemented as a data-structure, the use of the TFDB system database 553, 559, 565, 569 may be integrated into another module such as the DTFPS. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the TFDB database components includes several tables. The TFDB databases may have tables that store information relating to: call dispositional functionality, candidates' addresses, candidates' appointment schedules, candidates' demographics, candidates' registration, centralized service requests, test dates, test facility locations, and/or the like.

In one embodiment, the TFDB system database may interact with other database systems. For example, employing a distributed database system, queries and data access by the DTFPS system components may treat the combination of the TFDB system database as a single database entity. In one embodiment, user programs may contain various user interface primitives, which may serve to update the TFDB system. Also, various accounts may require custom database tables depending upon the environments and the types of clients a the TFDB system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The TFDB system may be configured to keep track of various settings, inputs, and parameters via database controllers. A the TFDB system database may communicate to and/or with other modules in a module collection, including itself, and/or facilities of the like. Most frequently, the TFDB system database communicates with the DTFPS system component, other program modules, and/or the like. The database may contain, retain, and provide information regarding other nodes and data.

Presentation and Business Layers

In one embodiment, the Interactive Voice Response (IVR) and Unified Contact Interface (UCI), e.g., Siebel, 539 comprise the contact center 529 portion of the presentation layer 519. The contact center is the interface that candidates may use to register and schedule for tests 231, 236 of FIG. 2 as well as make changes regarding scheduled tests. The UCI presentation layer 539 allows for common contact center platform access across all channels. The UCI presentation layer provides a unified interface for Web site registration and may use COM components 567 that may be accessed via XML. The COM components have a routing table and logic to allow UCI to access the UK Scheduling and Registration Database (UKSRDB) 569 for use by the contact center; i.e., the UKSRDB may store information relating to centralized service requests, call dispositional functionality, and candidate registration, candidate demographics. The contact center processes candidate registrations. The IVR 537 portions may be used to increase self services including confirmations and cancellations leading to a reduction in call volume in the contact center. In one embodiment, a voice actuated system is used to enable test candidates to interact with the system, whereby the IVR allows for voice prompt selections to access and modify such confirmation, cancellation, etc. functionality. An example voice actuated system, the Genesys Computer Telephony Integration, Inc., may be used. In another embodiment, call center personnel may field calls from candidates and make changes on the UCI interface on the candidate's behalf. The IVR similarly may access the UKSRDB 569 through the new COM objects interface 567. Similar to the interface 567 for the UKSRDB 569, a Serverlets interface 561, 527 may provide information to Enterprise JavaBeans (EJB) logic 563 before it is provided to the NRC database. The NRC database may be accessed by the business logic layer (e.g., scheduling rules defining the window of time when a test may be taken).

The IVR may access the Scheduling and Registration Authorized Performance Testing Centers (SRAPTC) Unified Database (UDB) database through an SRAPTC COM+ component interface 551. An XML wrapper 527, 549 is used to prepare information for the interface 551 for access and storage to the SRAPTC UDB. As the interface is instantiated 549, it is available to any of the presentation layer 519 components, including UCI 539. Similarly, XML wrapper 527, 555 may be used for a Universal Scheduling and Registration (USR) COM+ component layer 557 for access to the USR UDB.

Similarly, 3^{rd} party interfaces may be created to allow access to the UKSRDB 569. The instantiation 522 of the COM components 567, for example, allows the 3^{rd} party Test of English as a Foreign Language™ (TOEFL) 547 to not only access the UKSRDB 569, but it allows for IVR access to the UKSRDB 569 by TOEFL candidates in addition to their accessing their own registration information through the ets.org/toefl/index.htmlWeb site 548.

FIG. 6 shows an example of a third party presentation layer 547, 548 that accesses the Brokerage layer 521 and business layer 523 of the DTFPS. A TOEFL test candidate may provide the DTFPS with their location of interest for testing 548. The candidate may then select an option to schedule a test in that geographic area 605. After the DTFPS identifies several test facilities that provide TOEFL tests 610 (as has already been discussed in previous figures), the user may select one of the offered test facility sites 610. Thereafter, the DTFPS will present various test times available for that facility 615, and the user may make a selection for a convenient test time. Thereafter the DTFPS may provide the candidate with forms for obtaining personal information 620 and test payment information prior to completing the registration and scheduling for the test. Another example of a 3^{rd} party implementation is the GMAC.COM site 545, 546.

It should be noted that that because of the interface structure 522 of the Broker layer 521, and its multiple instantiations 549, 555, 561, 567, any one of the components of the presentation layer 519, may send one or numerous requests to one or more of the instantiated interfaces 549, 555, 561, 567 simultaneously. The over all design results in a federated series of databases 553, 559, 565, 569 that allows access and interaction with any of the presentation layer components 519 without re-coding all the business logic 551, 557, 563. This provides a highly orthogonal design, and allows for the various presentation areas 529, 531/533, 536 to leverage one another and one another's instantiated interfaces 549, 555, 561, 567, e.g., providing IVR 537 functionality to 3^{rd} parties 535.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. In describing embodiments of the invention, in some cases specific terminology has been used for the sake of clarity, however, the invention is not intended to be limited to and/or by the specific terms so selected, and it is to be understood that each specific term includes all technical equivalents which operate in a similar manner to accomplish a similar purpose. It should be noted that terms and or phraseology in this disclosure are not exhaustive in detail, and are not provided as definitive definitions. Rather, the terms are provided herein simply as an aid to the reader. The terms are not limiting of the disclosure and/or claims herein. The use of the terms may contemplate any of the broader, and/or multiple meanings found in common use, dictionaries, technical dictionaries, and/or in actual use in the technical arts, as well as any broadening made throughout this disclosure. Also, the advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of space and reducing repetition. For instance, it is to be understood that the logical and/or topological structure of any combination of any invention components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. Moreover, it should be recognized that manual operations may be used in lieu of various systemizations; e.g., generation of a request for testing facility availability may be created by receiving a telephone call from personnel at a test facility by a test provider that manually updates a TFDB and/or searches the TFDB as is required. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that aspects of the disclosure such as advantages, embodiments, examples, features, functional, logical, organizational, structural, topological, and/or other aspects are not to be considered limitations on the disclosure as defined by the claims or limitations on equivalents to the claims.

What is claimed is:

1. A method for allocating testing facility capacity and increase availability, comprising:
receiving a request for a test event, said request including testing facility requirements, including operational metric requirements;
searching for testing facilities in a testing facilities database that match the testing facility requirements;
generating approvals for test facilities identified from searching the testing facilities database, said approvals including contracts and work orders with the identified test facilities,
allocating testing facility capacity in accordance with the identified test facilities;
establishing new testing facilities, if no testing facilities are identified from said searching; and
updating the testing facilities database to include the identified test facilities and any new testing facilities.

2. A method for allocating testing facility capacity and increase availability, comprising:
receiving a request for a test event, said request including testing facility requirements;
searching for testing facilities in a testing facilities database that match the testing facility requirements;
generating approvals for test facilities identified from searching the testing facilities database;
allocating testing facility capacity in accordance with the identified test facilities.

3. The method of claim 2, wherein the testing facility requirements include operational metric requirements.

4. The method of claim 2, wherein the approvals include contracts and work orders with the identified test facilities.

5. The method of claim 2, further, comprising:
generating a request to establish new testing facilities, if no testing facilities are identified from said searching.

6. The method of claim 5, further, comprising:
establishing the new testing facilities based on the allocation of testing facility capacity and based on the generated request to establish new testing facilities.

7. The method of claim 2, further, comprising:
updating the testing facilities database to include the identified test facilities and any new testing facilities.

8. The method of claim 2, wherein the testing facilities database comprises a federated series of databases, and searching may occur across the federated databases.

9. The method of claim 2, wherein the searching occurs through a brokerage layer for the federated databases.

10. A method for allocating testing facility capacity and increase availability, comprising:
searching for testing facilities in a testing facilities database that match testing facility requirements;
allocating testing facility capacity in accordance with identified test facilities;
establishing new testing facilities, if no testing facilities are identified from the searching;
generating a request to establish new testing facilities, if no testing facilities are identified from said searching;

11. The method of claim 10, further, comprising:
establishing the new testing facilities based on the allocation of testing facility capacity and based on the generated request to establish new testing facilities.

12. The method of claim 11, further, comprising:
updating the testing facilities database to include the identified test facilities and any new testing facilities.

13. The method of claim 10, wherein the testing facilities database comprises a federated series of databases, and searching may occur across the federated databases.

14. The method of claim 10, wherein the searching occurs through a brokerage layer for the federated databases.

15. A method to determine testing facility availability, comprising:
obtaining desired characteristics for a testing facility,
wherein the desired characteristics are from testing facility requirements from a testing authority,
searching for testing facilities with the desired characteristics,
wherein the search takes place in a testing facility database and wherein the testing facility database comprises a federated series of databases, and data transactions may occur across the federated databases through a brokerage layer for the federated databases;
wherein the desired characteristics include specified geographic regions;
sending a request for testing facility availability,
wherein the request is triggered by updates to capacity demand for the testing facility,
wherein the request includes desired facility characteristics,
wherein the request is sent to testing facilities,
wherein the testing facilities are identified by the search results based on the desired characteristics;
receiving a response to the request from a testing facility;
updating the testing facility database with the response;
determining capacity demand for a testing facility,
wherein applications for the testing facility by test candidates dynamically affect the capacity demand.

16. A method, comprising:
obtaining desired characteristics for a testing facility,
sending a request for testing facility availability,
wherein the request is triggered by updates to capacity demand for the testing facility;
receiving a response to the request.

17. The method of claim 16, further, comprising:
updating the testing facility database with the response.

18. The method of claim 16, wherein the response is received from a testing facility.

19. The method of claim 16, wherein the testing facility database comprises a federated series of databases, and data transactions may occur across the federated databases through a brokerage layer for the federated databases.

20. The method of claim 16, wherein the desired characteristics are from testing facility requirements from a testing authority.

21. The method of claim 16, further, comprising:
searching for testing facilities with the desired characteristics,
wherein the testing facilities are identified by the search results based on the desired characteristics,
wherein the desired characteristics include specified geographic regions.

22. The method of claim 21, wherein the search takes place in a testing facility database.

23. The method of claim 21, wherein the search takes place in a testing facility database.

24. The method of claim 21, wherein the request includes desired facility characteristics.

25. The method of claim 21, wherein the request is sent to testing facilities.

26. The method of claim 16, further, comprising:
determining capacity demand for a testing facility,
wherein applications for the testing facility by test candidates dynamically affect the capacity demand,
wherein capacity demand is affected dynamically.

27. The method of claim 18, further, comprising:
establishing new testing facilities for a testing event.

28. The method of claim 16, wherein testing facilities may include fixed, temporary, and mobile facilities,
wherein testing facilities include testing infrastructure.

29. The method of claim 28, wherein mobile facilities may include a mobile home, a bus, a tractor-trailer, a recreation vehicle, and a van.

30. A method to increase testing facility availability, comprising:
receiving a request for a test event,
wherein the request includes testing facility requirements,
wherein the testing facility requirements include operational metric requirements;
searching for testing facilities in a testing facilities database that match the testing facility requirements,
wherein the testing facilities database comprises a federated series of databases, and data transactions may occur across the federated databases through a brokerage layer for the federated databases;
generating approvals for test facilities identified from searching the testing facilities database,
wherein the approvals are contracts with the identified test facilities,
wherein the approvals are work orders with the identified test facilities;
establishing new testing facilities, if no testing facilities are identified from searching;
updating the testing facilities database,
wherein the update to the testing facilities database includes the new testing facilities, and
wherein the update to the testing facilities database includes the identified test facilities.

31. A method, comprising:
receiving a request for a test event,
wherein the request includes testing facility requirements;
searching for testing facilities in a testing facilities database that match the testing facility requirements;
generating approvals for test facilities identified from searching the testing facilities database;
generating a request to establish new testing facilities, if no testing facilities are identified from searching.

32. The method of claim 31, further, comprising:
updating the testing facilities database.

33. The method of claim 31, further, comprising:
establishing the new testing facilities based on the generated request to establish new testing facilities.

34. The method of claim 31, wherein the testing facilities database comprises a federated series of databases, and data transactions may occur across the federated databases through a brokerage layer for the federated databases.

35. The method of claim 31, wherein the testing facility requirements include specified geographic regions,
wherein the testing facility requirements include operational metric requirements.

36. The method of claim 31, wherein multiple testing facilities are approved to supply requisite testing facility capacity.

37. The method of claim 31, wherein the approvals are contracts with the identified test facilities.

38. The method of claim 31, wherein the approvals are work orders with the identified test facilities.

39. The method of claim 31, wherein the update to the testing facilities database includes the new testing facilities, if established,
wherein the update to the testing facilities database includes the identified test facilities, if identified.

40. A method to schedule testing facilities, comprising:
receiving test candidate credentials;
obtaining a test candidate identifier based on the test candidate credentials,
wherein the test candidate identifier is unique to the test candidate;
receiving a scheduling request to participate in a test event,
wherein the scheduling request includes a test event identifier, the candidate identifier, and a desired location, date and time for the test candidate to participate in the test event;
determining availability of testing facilities that match the scheduling request,
wherein a testing facility database is searched for testing facilities that match the scheduling request;
scheduling the test candidate for the testing event, if testing facilities are available,
wherein a lowest cost testing facility is selected as the testing candidates testing facility if more than one testing facility is determined to be available;
determining if more testing facilities should be made available, if testing facilities are unavailable to the testing candidate,
wherein the testing authority's testing facility requirements determine if more facilities should be made available;
allocating additional testing facility capacity, if more facilities should be made available,
wherein multiple testing facilities may be allocated to supply requisite capacity;
providing alternative testing facilities, if more facilities should not be made available.

41. A method, comprising:
receiving test candidate credentials;
obtaining a test candidate identifier based on the test candidate credentials,
wherein the test candidate identifier is unique to the test candidate;
receiving a scheduling request to participate in a test event,
wherein the scheduling request includes a desired location and time for the test candidate to participate in the test event;
determining availability of testing facilities that match the scheduling request,
wherein a testing facility database is searched for testing facilities that match the scheduling request; and
scheduling the test candidate for the testing event, if testing facilities are available.

42. The method of claim 41, wherein the testing facility database comprises a federated series of databases,.and data transactions may occur across the federated databases through a brokerage layer for the federated databases.

43. The method of claim 41, wherein credentials are received by a test provider.

44. The method of claim 41, wherein credentials are received by a testing authority.

45. The method of claim 41, wherein the test candidate identifier is generated by the testing authority.

46. The method of claim 41, wherein the test candidate identifier is generated by the test provider.

47. The method of claim 41, wherein the scheduling request includes a test event identifier and the candidate identifier.

48. The method of claim 41, wherein a lowest cost testing facility is selected as the testing candidates testing facility if more than one testing facility is determined to be available.

49. The method of claim 41, further, comprising:
determining if more testing facilities should be made available, if testing facilities are unavailable to the testing candidate.

50. The method of claim 49, wherein the testing authority's testing facility requirements determine if more facilities should be made available.

51. The method of claim 49, wherein the testing authority's operational metric requirements determine if more facilities should be made available.

52. The method of claim 41, further, comprising:
allocating additional testing facility capacity, if more facilities should be made available,
providing alternative testing facilities, if more facilities should not be made available.

53. The method of claim 52, further, comprising:
establishing the new testing facilities based on additional testing facility capacity allocations.

54. The method of claim 52, wherein multiple testing facilities may be allocated to supply requisite capacity.

55. A method to generate tests, comprising:
receiving a test specification for a type of test,
wherein the test specification includes a test generation procedure,
wherein the test generation procedure is embodied as an SQL command,
wherein the test specification includes test questions, answers, and wrong answers;
wherein the test specification includes a test grading procedure;
parsing the test specification into its constituent test components,
wherein a test type identifier is obtained for the test specification;
storing the constituent test components in test database;
generating a test by applying the test generation procedure to the test database,
wherein the test generation procedure searches the test database for constituent test components related to the test type identifier;
updating the test database with generated tests, if the generated tests are approved.

56. A method, comprising:
receiving a test specification for a type of test,
wherein the test specification includes a test generation procedure;
parsing the test specification into its constituent test components,
wherein a test type identifier is obtained for the test specification;
storing the constituent test components in test database; and
generating a test by applying the test generation procedure to the test database.

57. The method of claim 31, wherein the test database comprises a federated series of databases, and data transactions may occur across the federated databases through a brokerage layer for the federated databases.

58. The method of claim 56, wherein the test generation procedure is embodied as an SQL command.

59. The method of claim 56, wherein the test specification may include test questions, answers, wrong answers, and a test grading procedure.

60. The method of claim 59, further, comprising:
generating a test results report by applying the test grading procedure to the test database,
wherein the test grading procedure searches the test database for constituent test results from a test candidate; and
updating the test database with generated tests, if the generated tests are approved.

61. The method of claim 56, wherein the test type identifier is generated by a test provider for a test authority.

62. The method of claim 56, wherein the test type identifier is provided by a test authority to a test provider.

63. The method of claim 56, wherein the test generation procedure searches the test database for constituent test components related to the test type identifier.

64. A method to report testing results, comprising:
receiving test results from a test candidate,
wherein the test results include a test facility identifier, a test identifier, and a test candidate identifier,
parsing the test results into its constituent test components,
storing the constituent test components in a test results database,
generating a test results report by searching the test results database,
wherein the test results database is searched for constituent test results components based on the test facility identifier, the test identifier, and the test candidate identifier,
providing the test results report,
wherein the test results report is provided to the candidate;
wherein the test results report is provided to the test authority.

65. The method of claim 64, wherein the test results database comprises a federated series of databases, and data transactions may occur across the federated databases through a brokerage layer for the federated databases.

66. A system for allocating testing facility capacity and increase availability, comprising:
means to receive a request for a test event, said request including testing facility requirements;
means to search for testing facilities in a testing facilities database that match the testing facility requirements;
means to generate approvals for test facilities identified from searching the testing facilities database;
means to allocate testing facility capacity in accordance with the identified test facilities.

67. A system for allocating testing facility capacity and increase availability, comprising:
means to search for testing facilities in a testing facilities database that match testing facility requirements;
means to allocate testing facility capacity in accordance with identified test facilities;
means to establish new testing facilities, if no testing facilities are identified from the searching;
means to generate a request to establish new testing facilities, if no testing facilities are identified from said searching;

68. A system to ascertain testing facility availability, comprising:
means to obtain desired characteristics for a testing facility,
means to send a request for testing facility availability,
wherein the request is triggered by updates to capacity demand for the testing facility;
means to receive a response to the request.

69. A system for testing facility availability, comprising:
means to receive a request for a test event,
wherein the request includes testing facility requirements;
means to search for testing facilities in a testing facilities database that match the testing facility requirements;
means to generate approvals for test facilities identified from searching the testing facilities database;
means to generate a request to establish new testing facilities, if no testing facilities are identified from searching.

70. A system to schedule test candidates, comprising:
means to receive test candidate credentials;
means to obtain a test candidate identifier based on the test candidate credentials,
wherein the test candidate identifier is unique to the test candidate;
means to receive a scheduling request to participate in a test event,
wherein the scheduling request includes a desired location and time for the test candidate to participate in the test event;
means to determine availability of testing facilities that match the scheduling request,
wherein a testing facility database is searched for testing facilities that match the scheduling request; and
means to schedule the test candidate for the testing event, if testing facilities are available.

71. A system to generate a test, comprising:
means to receive a test specification for a type of test,
wherein the test specification includes a test generation procedure;
means to parsing the test specification into its constituent test components,
wherein a test type identifier is obtained for the test specification;
means to store the constituent test components in test database; and
means to generate a test by applying the test generation procedure to the test database.

72. A system to report testing results, comprising:
receive test results from a test candidate,
wherein the test results include a test facility identifier, a test identifier, and a test candidate identifier,
means to parse the test results into its constituent test components,
means to store the constituent test components in a test results database,
means to generate a test results report by searching the test results database,
wherein the test results database is searched for constituent test results components based on the test facility identifier, the test identifier, and the test candidate identifier,
means to provide the test results report,
wherein the test results report is provided to the candidate; and
wherein the test results report is provided to the test authority.

73. A medium readable by a processor to allocate testing facility capacity and increase availability, comprising:
instruction signals in the processor readable medium, wherein the instruction signals are issuable by the processor to:
receive a request for a test event, said request including testing facility requirements;
search for testing facilities in a testing facilities database that match the testing facility requirements;
generate approvals for test facilities identified from searching the testing facilities database;
allocate testing facility capacity in accordance with the identified test facilities.

74. A medium readable by a processor to allocate testing facility capacity and increase availability, comprising:
instruction signals in the processor readable medium, wherein the instruction signals are issuable by the processor to:
search for testing facilities in a testing facilities database that match testing facility requirements;
allocate testing facility capacity in accordance with identified test facilities;
establish new testing facilities, if no testing facilities are identified from the searching;
generate a request to establish new testing facilities, if no testing facilities are identified from said searching;

75. A medium readable by a processor to ascertain testing facility availability, comprising:
instruction signals in the processor readable medium, wherein the instruction signals are issuable by the processor to:
obtain desired characteristics for a testing facility,
send a request for testing facility availability,
wherein the request is triggered by updates to capacity demand for the testing facility;
receive a response to the request.

76. A medium readable by a processor for testing facility availability, comprising:
instruction signals in the processor readable medium, wherein the instruction signals are issuable by the processor to:
receive a request for a test event,
wherein the request includes testing facility requirements;
search for testing facilities in a testing facilities database that match the testing facility requirements;
generate approvals for test facilities identified from searching the testing facilities database;
generate a request to establish new testing facilities, if no testing facilities are identified from searching.

77. A medium readable by a processor to schedule test candidates, comprising:
instruction signals in the processor readable medium, wherein the instruction signals are issuable by the processor to:
receive test candidate credentials;
obtain a test candidate identifier based on the test candidate credentials,
wherein the test candidate identifier is unique to the test candidate;
receive a scheduling request to participate in a test event,
wherein the scheduling request includes a desired location and time for the test candidate to participate in the test event;
determine availability of testing facilities that match the scheduling request,
wherein a testing facility database is searched for testing facilities that match the scheduling request; and
schedule the test candidate for the testing event, if testing facilities are available.

78. A medium readable by a processor to generate a test, comprising:
instruction signals in the processor readable medium, wherein the instruction signals are issuable by the processor to:
receive a test specification for a type of test,
wherein the test specification includes a test generation procedure;
parsing the test specification into its constituent test components,
wherein a test type identifier is obtained for the test specification;
store the constituent test components in test database; and
generate a test by applying the test generation procedure to the test database.

79. A medium readable by a processor to report testing results, comprising:
instruction signals in the processor readable medium, wherein the instruction signals are issuable by the processor to:
receive test results from a test candidate,
wherein the test results include a test facility identifier, a test identifier, and a test candidate identifier,
parse the test results into its constituent test components,
store the constituent test components in a test results database,
generate a test results report by searching the test results database,
wherein the test results database is searched for constituent test results components based on the test facility identifier, the test identifier, and the test candidate identifier,
provide the test results report,
wherein the test results report is provided to the candidate; and
wherein the test results report is provided to the test authority.

80. An apparatus to allocate testing facility capacity and increase availability, comprising:
a memory;
a processor disposed in communication with said memory, and configured to issue a plurality of processing instructions stored in the memory, wherein the instructions issue signals to:
receive a request for a test event, said request including testing facility requirements;
search for testing facilities in a testing facilities database that match the testing facility requirements;
generate approvals for test facilities identified from searching the testing facilities database;
allocate testing facility capacity in accordance with the identified test facilities.

81. An apparatus to allocate testing facility capacity and increase availability, comprising:
instruction signals in the processor readable medium, wherein the instruction signals are issuable by the processor to:
search for testing facilities in a testing facilities database that match testing facility requirements;
allocate testing facility capacity in accordance with identified test facilities;
establish new testing facilities, if no testing facilities are identified from the searching;
generate a request to establish new testing facilities, if no testing facilities are identified from said searching;

82. An apparatus to ascertain testing facility availability, comprising:
a memory;
a processor disposed in communication with said memory, and configured to issue a plurality of processing instructions stored in the memory, wherein the instructions issue signals to:
obtain desired characteristics for a testing facility,
send a request for testing facility availability,
wherein the request is triggered by updates to capacity demand for the testing facility;
receive a response to the request.

83. An apparatus for testing facility availability, comprising:
instruction signals in the processor readable medium, wherein the instruction signals are issuable by the processor to:
receive a request for a test event,
wherein the request includes testing facility requirements;
search for testing facilities in a testing facilities database that match the testing facility requirements;
generate approvals for test facilities identified from searching the testing facilities database;
generate a request to establish new testing facilities, if no testing facilities are identified from searching.

84. An apparatus to schedule test candidates, comprising:
a memory;
a processor disposed in communication with said memory, and configured to issue a plurality of processing instructions stored in the memory, wherein the instructions issue signals to:
receive test candidate credentials;
obtain a test candidate identifier based on the test-candidate credentials,
wherein the test candidate identifier is unique to the test candidate;
receive a scheduling request to participate in a test event,
wherein the scheduling request includes a desired location and time for the test candidate to participate in the test event;
determine availability of testing facilities that match the scheduling request,
wherein a testing facility database is searched for testing facilities that match the scheduling request; and
schedule the test candidate for the testing event, if testing facilities are available.

85. An apparatus to generate a test, comprising:
a memory;
a processor disposed in communication with said memory, and configured to issue a plurality of processing instructions stored in the memory, wherein the instructions issue signals to:
receive a test specification for a type of test,
wherein the test specification includes a test generation procedure;
parsing the test specification into its constituent test components,
wherein a test type identifier is obtained for the test specification;
store the constituent test components in test database; and
generate a test by applying the test generation procedure to the test database.

86. An apparatus to report testing results, comprising:
a memory;
a processor disposed in communication with said memory, and configured to issue a plurality of processing instructions stored in the memory, wherein the instructions issue signals to:
receive test results from a test candidate,
wherein the test results include a test facility identifier, a test identifier, and a test candidate identifier,
parse the test results into its constituent test components,
store the constituent test components in a test results database,
generate a test results report by searching the test results database,
wherein the test results database is searched for constituent test results components based on the test facility identifier, the test identifier, and the test candidate identifier,
provide the test results report,
wherein the test results report is provided to the candidate; and
wherein the test results report is provided to the test authority.
